(19) United States
(12) Patent Application Publication
(10) Pub. No.: US 2009/0065069 A1
(43) Pub. Date: Mar. 12, 2009

(54) MODULAR SERVICE SADDLE

(75) Inventors: Petrus J. Pretorius, Surrey (CA); Reginald Police, Delta (CA); David C. Brewer, Mission (CA); Anthony L. Kuwica, Langley (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: ROBAR INDUSTRIES LTD., Surrey (CA)

(21) Appl. No.: 12/137,499

(22) Filed: Jun. 11, 2008

Related U.S. Application Data
(60) Provisional application No. 60/944,851, filed on Jun. 19, 2007.

(51) Int. Cl. F16L 55/18

(52) U.S. Cl. 137/318

(57) ABSTRACT

A modular outlet is used with a service saddle strap so that different outlets that can be connected to different size lines can be used with the same saddle strap.

### REFERENCE TO RELATED APPLICATION

This application claims the benefit of U.S. provisional application No. 60/944,851 filed Jun. 19, 2007 entitled “Modular Service Saddle”, which is incorporated herein by reference.

### TECHNICAL FIELD

The invention relates to the design and construction of service saddles used in connection with water mains and the like.

### BACKGROUND

Pipe saddle assemblies, referred to generally as service saddles, are used to connect secondary pipe lines, such as service water lines, to a larger main pipe line, such as an underground water main. A service saddle is used to create a lateral connection from an existing main where no line valve was previously, and this is done without service interruption. The saddle is generally connected to the main line while the main line is under full pressure. After clamping the saddle onto the existing pipe, a tapping machine is connected through an outlet on the saddle to tap a hole through the main and the service line is then connected to the outlet. See for example U.S. Pat. No. 2,703,721 and U.S. Pat. No. 5,000,489.

The outlet on the service saddle currently is welded to the saddle. This has a number of disadvantages. Different saddles have to be stocked by the distributor for various sizes of service lines. Bad installation can result in a leak due to poor sealing. A flawed weld at the outlet section can cause a failure and welding increases production cost and increases potential for corrosion.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

The invention provides a modular service saddle for connecting a main pipe line to a secondary pipe line, comprising: i) a modular saddle outlet comprising a base adapted on a first side thereof to sealingly engage the main pipe line and an extension extending from a second side of the base with a cylindrical bore extending therethrough, the cylindrical bore adapted for threadably receiving the secondary pipe line; and ii) a flexible cylindrical saddle body section for positioning coaxially on the main pipe with the base of the modular saddle outlet positioned between the saddle body and the main pipe line, and comprising means for tightening the saddle body on the main pipe line and an opening sized to permit the extension of the modular saddle outlet to extend therethrough.

The invention further provides a method of connecting a main pipe line to a secondary pipe line, comprising: a) providing a modular service saddle comprising; i) a plurality of modular saddle outlets, each comprising a base adapted on a first side thereof to sealingly engage the main pipe line and an extension extending from a second side of the base with a cylindrical bore extending therethrough, the cylindrical bore adapted for threadably receiving the secondary pipe line, wherein the cylindrical bore of each modular saddle outlets is provided with one of a plurality of different thread types or diameters; ii) a flexible cylindrical saddle body section for positioning coaxially on the main pipe with the base of the modular saddle outlet positioned between the saddle body and the main pipe line, and comprising means for tightening the saddle body on the main pipe line and an opening sized to permit the extension of the modular saddle outlet to extend therethrough; b) determining the thread type and diameter of the secondary pipe line; c) selecting one of the plurality of modular saddle outlets which is appropriate for the secondary pipe line; d) installing the modular service saddle incorporating the selected modular saddle outlet on the main pipe line; and e) connecting the secondary line to the modular saddle outlet.

In addition to the exemplary aspects and embodiments described above, further aspects and embodiments will become apparent by reference to the drawings and by study of the following detailed descriptions.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 is an isometric view of a first embodiment of the invention being installed on a main pipe line.

FIG. 2 is a top perspective view of the outlet shown in FIG. 1.

FIG. 3 is a bottom perspective view of the outlet shown in FIG. 1 with O-ring removed.

FIG. 4 is a top view of the outlet shown in FIG. 2.

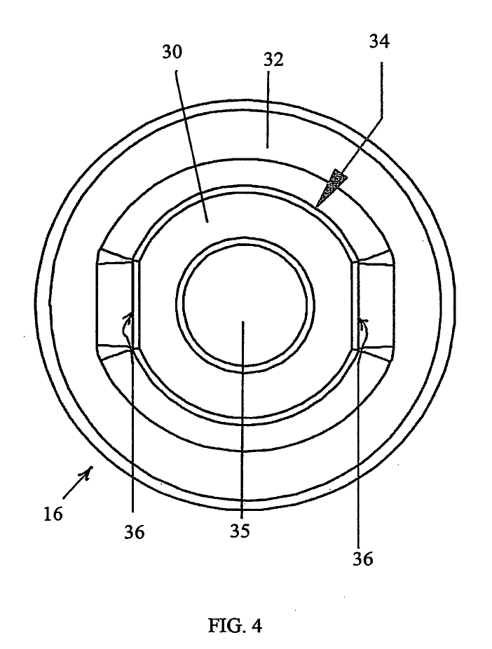

FIG. 5 is a bottom view of the outlet shown in FIG. 2.

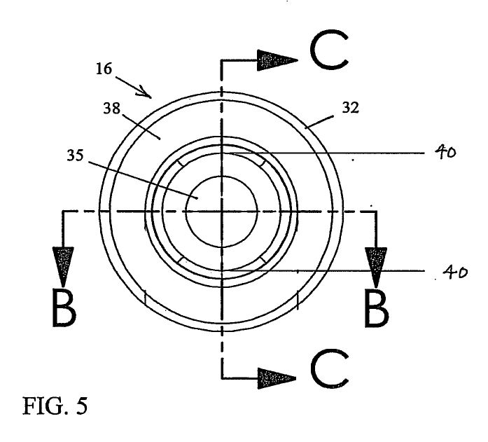

FIG. 6 is a cross-section taken along lines B-B of FIG. 5.

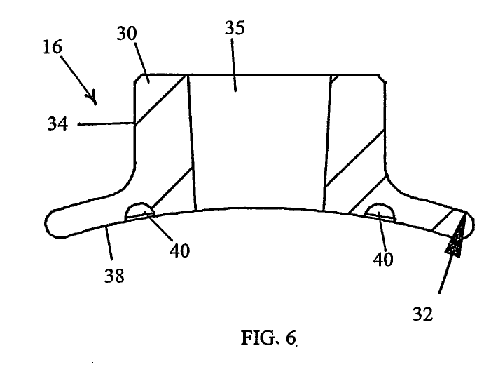

FIG. 7 is a cross-section taken along lines C-C of FIG. 5.

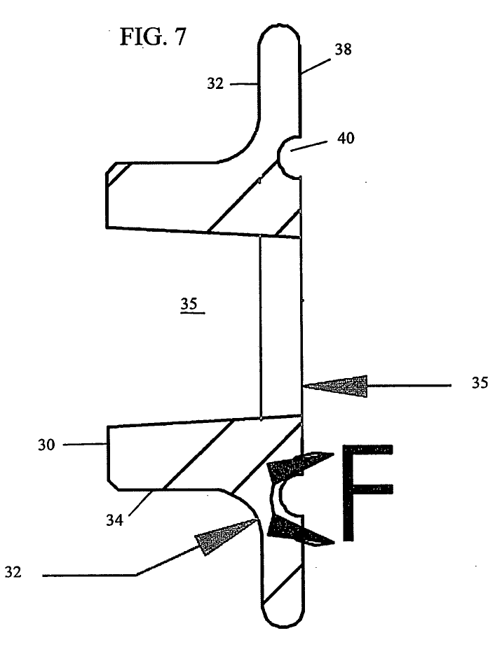

FIG. 8 is a detail view of area F of the cross-section shown in FIG. 7.

FIG. 9 is an isometric view of a second embodiment of the outlet used with the invention.

FIG. 10 is an isometric view of the saddle body in isolation.

FIG. 11 is a bottom perspective view of the outlet shown in FIG. 1 with an O-ring in place.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

The present invention uses a modular outlet so that different outlets that can be connected to different size lines can be used with the same saddle strap. The modular outlet, shaped like a hat, has a groove on the underside of the “brim” to receive an O-ring for sealing around the hole in the main pipe. The modular outlet sits under a boss in the saddle strap which has a hole through which the cylindrical “dome” of the outlet extends. The desired size outlet is selected, placed under the saddle boss and the saddle strap is tightened onto the main pipe.

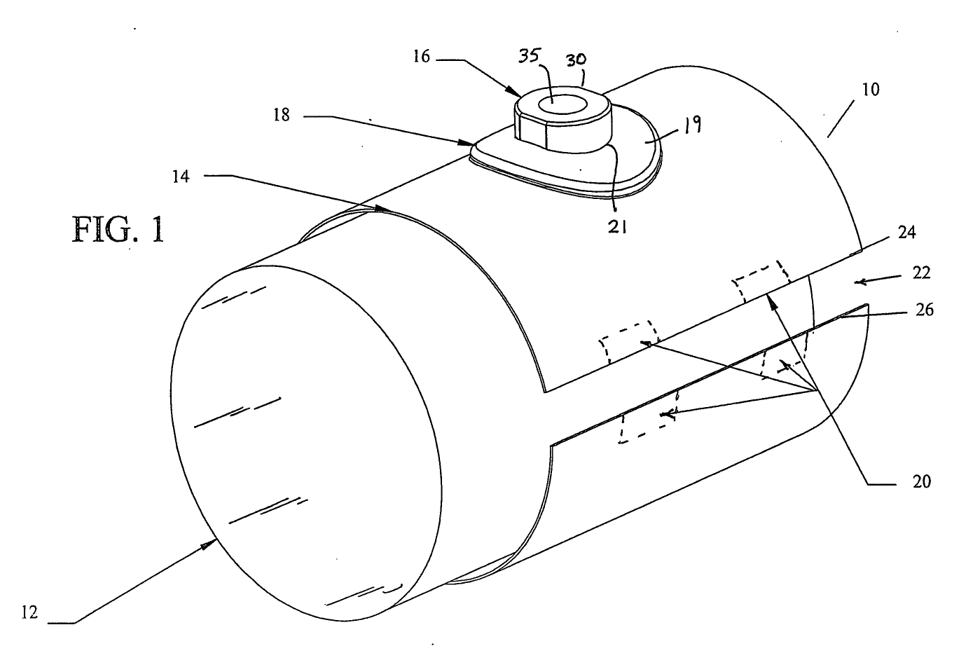

Referring to FIG. 1, a modular service saddle 10 according to the invention is illustrated in position to be installed on a main pipe line 12, such as a water main. Modular service saddle 10 has a flexible cylindrical saddle strap, referred to herein as the saddle body section 14 made of a strong, flexible, corrosion-resistant material such as metal plate, ductile iron, stainless steel or PVC. Saddle body 14 has opening 22 formed by opposed edges 24, 26 extending parallel with the lengthwise axis of the cylindrical saddle body 14. In this way saddle body 14 can be positioned coaxially on pipe 12 by separating edges 24, 26 to increase the size of opening 22. Closures 20, not shown in detail for clarity, are provided to clamp the saddle body 14 tightly on pipe 12. Closures 20 may be, for example, any existing bolt and nut clamping assemblies or band clamps which can be tightened by rotation of a threaded screw.

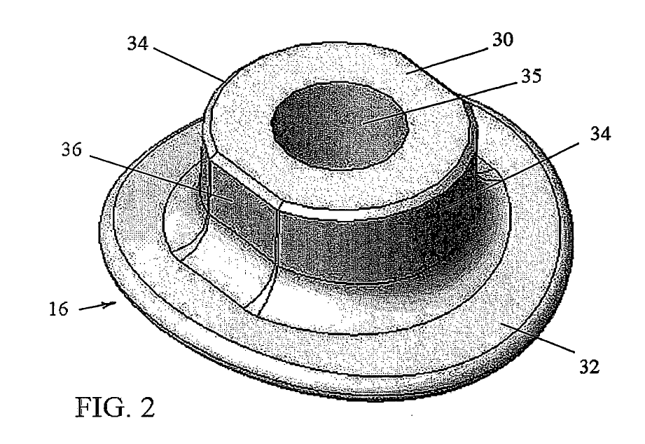

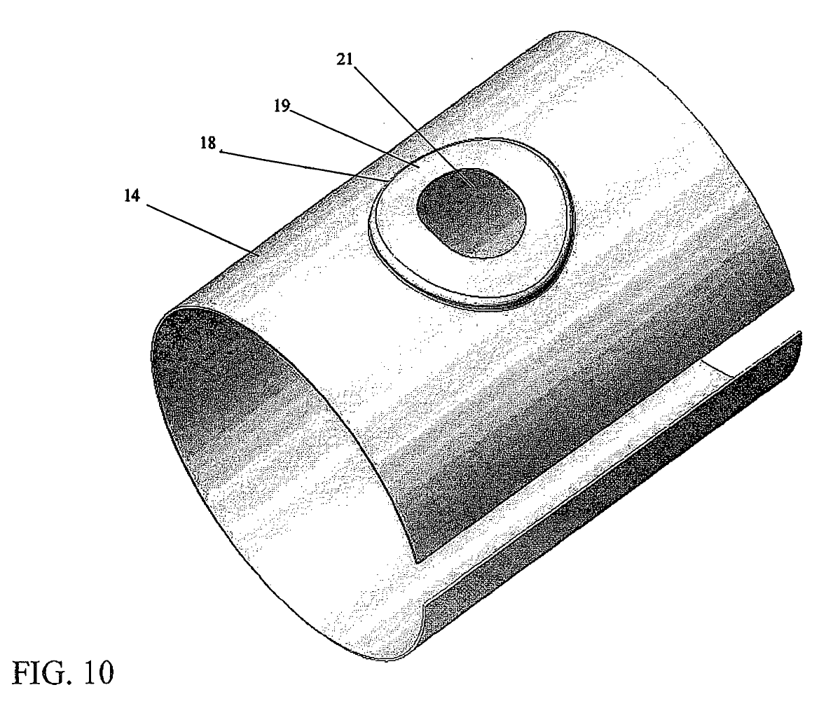

Formed in saddle body 14 (FIG. 10) is a boss 18 having a flange 19 which has a generally obround opening 21 sized to receive the generally obround cylindrical extension 30 of a modular saddle outlet 16, which is a separate piece as shown in FIGS. 2, 3 and 11. Modular saddle outlet 16 has a generally disc-shaped brim 32 which joins the vertical face 34 of cylindrical extension 30. Central aperture 35 is threaded and sized to receive the threaded connection from a secondary pipe (not shown). Different outlets 16 are provided with central apertures 35 of varying diameter and threads to accommodate corporation stops and/or secondary pipes of differing sizes and types. For example some outlets may be IP (Iron Pipe) threads, some with NPT (National Pipe Tapered) or CC (Corporation Cock) threads and of various diameters. Vertical face 34 may have flat parallel faces 36 to which a wrench may be applied for securing the outlet when pipes are being threaded into it. Outlet 16 may be formed of cast iron, brass, stainless steel or other materials such as high density dpolyethylene or nylon.

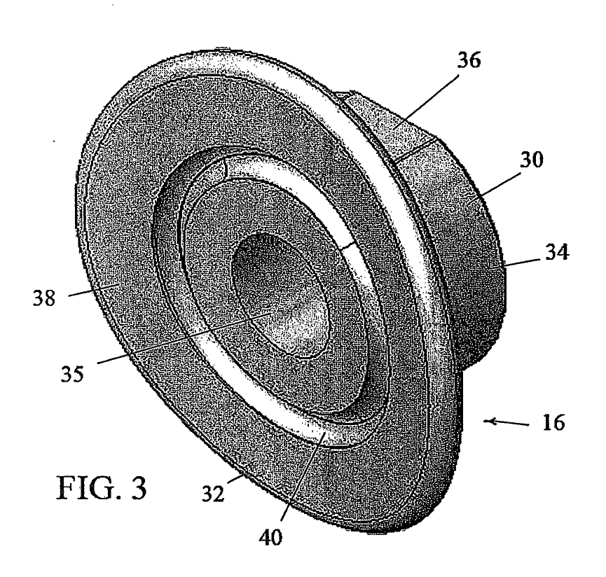

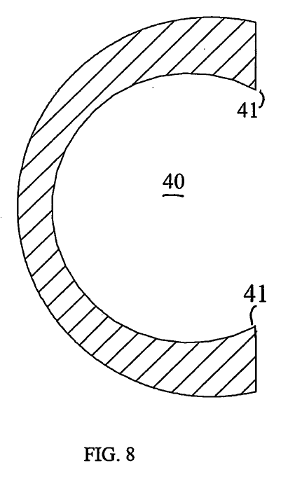

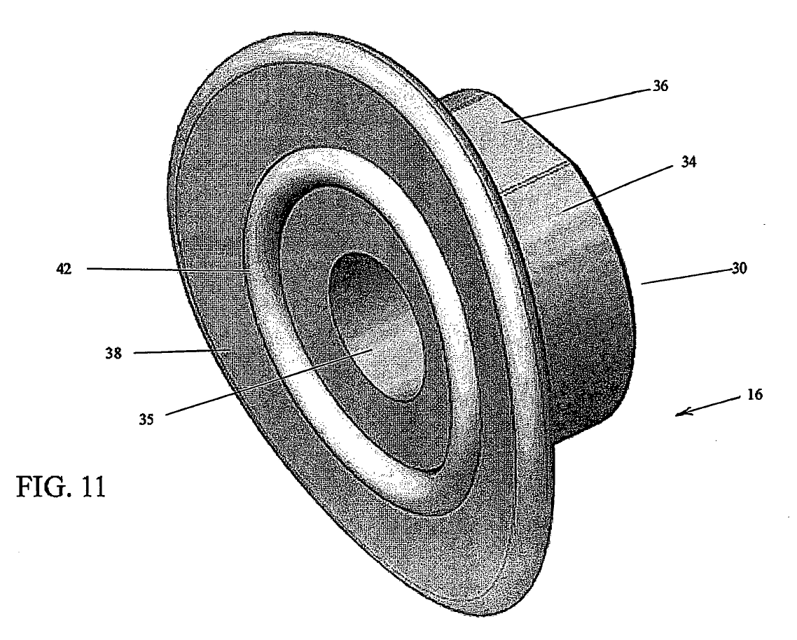

As shown in FIG. 3, outlet 16 is provided with a circular groove 40 on the underside 38 of the brim 32 to receive an O-ring 42 (FIG. 11) for sealing around the hole formed in the main pipe 12 by the tapping machine. FIG. 8 shows a cross-section of the groove 40 in exaggerated detail to illustrate undercut edges 41 which assist in retaining the O-ring 42 in groove 40. FIG. 11 illustrates the outlet 16 with O-ring 42 installed in groove 40.

In operation, the vicinity of the main pipe 12 is dug out until the pipe is exposed around its entire circumference. The pipe 12 is cleaned to remove loose rust or clay to ensure a reasonably clean and smooth surface. The pipe surface is lubricated with a potable lubricant such as soapy water. The desired size saddle body 14 for the main pipe 12 and outlet 16 size for the secondary pipe are selected and the O-ring/gasket 42 installed in the modular saddle outlet 16 and the modular saddle outlet 16 is positioned under flange 19 of boss 18 with extension 30 of a modular saddle outlet 16 extending through opening 21. The saddle 10 is then strapped onto the pipe in the desired location as follows. The closure mechanisms 20 on the saddle body 14 are opened, for example by backing off the nuts to the end of the bolts. The O-ring gasket 42 is lubricated, preferably with soapy water, and the saddle body 14 is placed on the main pipe 12 in the desired location with the modular saddle outlet 16 in the proper position, with flat sides 34 perpendicular to the pipe's longitudinal axis. Where lifter bars are used as the closure mechanism 20, these are snapped into position and the nuts tightened evenly to the desired torque. Once the desired torque is achieved, the saddle 10 is inspected for proper fit and positioning and the main stop (corporation stop) or valve is installed using Teflon tape. Once the corporation stop has been torqued into the saddle outlet 16, the drilling machine is installed and the corporation stop is opened. The drilling operation is then performed, the corporation stop is closed and the drilling machine is removed. The new branch line is then hooked up, the corporation stop is opened to pressurize the branch line and the connection is checked for leaks. The strap nuts are tightened to the specified torque value and the excavation is backfilled.

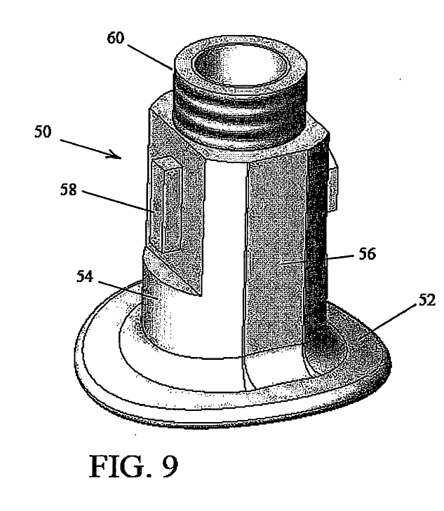

FIG. 9 illustrates a second embodiment of the modular saddle outlet 50 which incorporates a main valve. It has a brim 52 as in the previous embodiment and the cylindrical extension 54 with parallel flat surfaces 56. In this case a valve is provided in the cylindrical extension having a rotatable valve handle 58, shown in the open position, and a threaded extension 60 for attaching the secondary pipe.

While a number of exemplary aspects and embodiments have been discussed above, those of skill in the art will recognize certain modifications, permutations, additions and sub-combinations thereof. It is therefore intended that the invention be interpreted to include all such modifications, permutations, additions and sub-combinations as are within its true spirit and scope.

What is claimed is:

1. A modular service saddle for connecting a main pipe line to a secondary pipe line, comprising:
i) a modular saddle outlet comprising a base adapted on a first side thereof to sealingly engage said main pipe line and an extension extending from a second side of said base with a cylindrical bore extending therethrough, said cylindrical bore adapted for threadably receiving said secondary pipe line; and
ii) a flexible cylindrical saddle body section for positioning coaxially on said main pipe with the base of said modular saddle outlet positioned between said saddle body and said main pipe line, and comprising means for tightening said saddle body on said main pipe line and an opening sized to permit said extension of said modular saddle outlet to extend therethrough.

2. The modular service saddle of claim 1 comprising a plurality of said modular saddle outlets, said cylindrical bore of each of said plurality of modular saddle outlets having one of a plurality of different diameters.

3. The modular service saddle of claim 1 comprising a plurality of said modular saddle outlets, said cylindrical bore of each said plurality of modular saddle outlets being provided with one of a plurality of different thread types to accommodate corporation stops or secondary pipes of differing types.

4. The modular service saddle of claim 3 wherein said different thread types are selected from the group consisting of IP (Iron Pipe) threads, NPT (National Pipe Tapered) and CC (Corporation Cock) threads.

5. The modular service saddle of claim 1 wherein said base of said modular saddle outlet comprises a disc-shaped brim connected to said extension.

6. The modular service saddle of claim 1 wherein said saddle body is provided with a lengthwise opening parallel with the lengthwise axis of said cylindrical saddle body for positioning said saddle body coaxially on said main pipe and said means for tightening comprise closure means for closing said opening.

7. The modular service saddle of claim 1 wherein said saddle body comprises a boss having a flange for receiving said base of said modular saddle outlet.

8. The modular service saddle of claim 1 wherein said base of said modular saddle outlet is received in a raised area of said saddle body comprising a flange surrounding said opening sized to receive said extension of a modular saddle outlet.

9. The modular service saddle of claim 1 wherein said flexible cylindrical saddle body is constructed from a corrosion-resistant material.

10. The modular service saddle of claim 9 wherein said corrosion-resistant material is selected from the group consisting of metal plate, ductile iron, stainless steel and PVC.

11. The modular service saddle of claim 6 wherein said closure means comprises clamping means.

12. The modular service saddle of claim 1 wherein said outlet is constructed of a material selected from the group consisting of cast iron, brass, stainless steel, high density polyethylene and nylon.

13. The modular service saddle of claim 1 wherein said outlet further comprises a valve on said extension.

14. The modular service saddle of claim 1 wherein said extension of said modular saddle outlet comprises flat parallel faces to which a tool may be applied for securing said outlet when pipes are being threaded into it.

15. The modular service saddle of claim 1 wherein said base of said modular saddle outlet is adapted on a first side thereof to sealingly engage said main pipe line by being provided with an O-ring secured in and extending from the surface of said first side.

16. The modular service saddle of claim 1 wherein said O-ring is secured in and extending from the surface of said first side by being releasably retained in a circular groove therein.

17. The modular service saddle of claim 1 wherein said circular groove has undercut upper edges.

18. A method of connecting a main pipe line to a secondary pipe line, comprising:
a) providing a modular service saddle comprising;
i) a plurality of modular saddle outlets, each comprising a base adapted on a first side thereof to sealingly engage said main pipe line and an extension extending from a second side of said base with a cylindrical bore extending therethrough, said cylindrical bore adapted for threadably receiving said secondary pipe line, wherein said cylindrical bore of each said modular saddle outlets is provided with one of a plurality of different thread types or diameters;
ii) a flexible cylindrical saddle body section for positioning coaxially on said main pipe with the base of said modular saddle outlet positioned between said saddle body and said main pipe line, and comprising means for tightening said saddle body on said main pipe line and an opening sized to permit said extension of said modular saddle outlet to extend therethrough;
b) determining the thread type and diameter of said secondary pipe line;
c) selecting one of said plurality of modular saddle outlets which is appropriate for said secondary pipe line;
d) installing said modular service saddle incorporating said selected modular saddle outlet on said main pipe line; and
e) connecting said secondary line to said modular saddle outlet.
